(19) United States
(12) Patent Application Publication
(10) Pub. No.: US 2018/0276267 A1
(43) Pub. Date: Sep. 27, 2018

(54) METHODS AND SYSTEM FOR EFFICIENTLY PERFORMING EVENTUAL AND TRANSACTIONAL EDITS ON DISTRIBUTED METADATA IN AN OBJECT STORAGE SYSTEM

(71) Applicant: NEXENTA SYSTEMS, INC., Santa Clara, CA (US)

(72) Inventor: Caitlin BESTLER, Sunnyvale, CA (US)

(73) Assignee: NEXENTA SYSTEMS, INC., Santa Clara, CA (US)

(21) Appl. No.: 15/469,331

(22) Filed: Mar. 24, 2017

(51) Int. Cl. G06F 17/30

(52) U.S. Cl. CPC G06F 17/30371; G06F 17/30864; G06F 17/30377

(57) ABSTRACT

The present disclosure provides a method performed by an object storage cluster with distributed metadata. The distributed metadata is defined and stored in a form so as to be guaranteed to be commutative. For eventual edits to the distributed metadata, the system accumulates the edits for subsequent batch processing at relevant storage servers. For transactional edits to the distributed metadata, the system has the relevant storage servers perform a targeted search for older eventual edits to the distributed metadata for the same target object in the accumulation of eventual edits at the relevant storage servers. Before performing the transactional edit, any older eventual edits found by the targeted search are performed by the relevant storage servers.

### TECHNICAL FIELD

The present disclosure relates to object storage systems with distributed metadata.

### BACKGROUND

With the increasing amount of data is being created, there is increasing demand for data storage solutions. Storing data using a cloud storage service is a solution that is growing in popularity. A cloud storage service may be publicly-available or private to a particular enterprise or organization.

A cloud storage system may be implemented as an object storage cluster that provides “get” and “put” access to objects, where an object includes a payload of data being stored. The payload of an object may be stored in parts referred to as “chunks”. Using chunks enables the parallel transfer of the payload and allows the payload of a single large object to be spread over multiple storage servers.

An object storage cluster may be used to store files organized in a hierarchical directory. Conventionally, a directory separator character may be utilized between each layer of a fully-qualified name. The fully-qualified name for a file (or, more generally, for an object) may include: one tenant name; one or more folder names; a local name relative to a final enclosing folder. Each folder name may be interpreted in the context of the tenant and earlier folder names. In other words, the folders may be hierarchical folders as in a traditional file system. The directory separator character may most typically be the forward slash “/”. On traditional Windows file systems, it is a backwards slash “\”. The “|” and “:” characters have also been used as directory separators.

Many object storage clusters are capable of retaining multiple versions of each object. Default operations will get the most current version, but requests can be made for specific prior versions.

Metadata for objects stored in a conventional object storage cluster may be stored and accessed centrally. Recently, consistent hashing has been used to eliminate the need for such centralized metadata. Instead, the metadata may be distributed over multiple storage servers in the object storage cluster.

### SUMMARY

Object storage clusters may offer relaxed ordering rules that provide “eventual consistency”. With eventual consistency, the completion of a transaction guarantees that barring some configured level of hardware failure that the newly put object version will not be lost, and that this version will be available to other clients eventually. However, there is no guarantee that it will be available to other clients immediately.

This contrasts with the guarantees typically offered by distributed file systems, which are usually referred to as “transactional consistency”. When a transaction is committed successfully, all new versions created by that transaction will be visible to any other client's transaction initiated after that transaction closed. Providing transactional consistency requires more end-to-end communication than is required to provide eventual consistency.

It is advantageous for a storage cluster to offer access to the same set of documents via either an object storage API (application program interface) or via a file access API. This goal can be met by simply providing transactional consistency for both the object and file APIs; however, it would be preferable to minimize the impact of providing transactional consistency to file API clients.

Providing eventual consistency is relatively straightforward when the edits to the objects are guaranteed to be commutable. This is because the same set of edits can be applied to a given object in any order and the result will be the same. By contrast, the edits to a file under a file system API must be applied to the file in a consistent order for all instances of the file to yield the correct results. If the ordering of the edits is inconsistent among the instances of the file, then the resultant instances of the file may not match up with each other.

As disclosed herein, it can be advantageous in an object storage system with distributed metadata for metadata to be defined the storage servers to so that edit operations to the metadata are guaranteed to be commutative. Eventual edits to the guaranteed-commutative metadata may then be accumulated for subsequent batch processing which improves efficiency. This is possible because eventual edits require only eventual completion of the edit, and the order of the application of the edits does not matter for the guaranteed-commutative metadata.

However, while eventual edits to the guaranteed-commutative metadata may be accumulated at the storage servers for batch processing, transactional edits to the same metadata (for example, a metadata edit associated with a POSIX-compliant file write command) cannot be accumulated in the same manner. This is because transactional edits to data require actual completion of the edit with the transaction (not eventually).

Unfortunately, a transactional edit to guaranteed-commutative metadata cannot be completed legitimately if there are any pending eventual edits to the same metadata. A straightforward solution to this problem is to provide a system that, when faced with a batch of transactional edits to perform, performs all accumulated eventual edits so that the batch of transactional edits may be completed.

However, performing all the accumulated eventual edits is disadvantageously inefficient in that it uses substantial system resources and bandwidth, along with causing substantial latency, before the transactional edits may be completed. Moreover, this straightforward solution reduces the average allowable time to accumulate eventual transactions for the efficient processing of them in batches.

The present disclosure provides a targeted solution that efficiently deals with the aforementioned problems and disadvantages. The targeted solution uses a highly-targeted search to discover the minimal necessary eventual edits that need to be performed before a transactional edit may be completed. Advantageously, this targeted solution uses less system resources and bandwidth, causes less latency, and also has minimal effect on the average allowable time to accumulate eventual transactions for efficient batch processing.

### BRIEF DESCRIPTION OF THE DRAWINGS

FIG. 1 is a diagram of data in an exemplary implementation of a distributed object storage system and indicating the data that is guaranteed to be commutative and the data that is not guaranteed to be commutative in accordance with an embodiment of the invention.

FIG. 2A is a flow chart of a method of performing an eventual edit of guaranteed-commutative data stored in a distributed object storage system in accordance with an embodiment of the invention.

FIG. 2B is a flow chart of a method of performing a transactional edit of non-guaranteed-commutative data stored in a distributed object storage system in accordance with an embodiment of the invention.

FIG. 3 depicts an, exemplary object storage system in which the presently-disclosed solutions may be implemented.

FIG. 4 depicts a distributed namespace manifest and local transaction logs for each storage server of an exemplary storage system in which the presently-disclosed solutions may be implemented.

FIG. 5A depicts an exemplary relationship between an object name received in a put operation, namespace manifest shards, and the namespace manifest.

FIG. 5B depicts an exemplary structure of one types of entry that can be stored in a namespace manifest shard.

FIG. 5C depicts an exemplary structure of another type of entry that can be stored in a namespace manifest shard.

FIG. 6 depicts a hierarchical structure for the storage of an object into chunks in accordance with embodiment of the invention.

FIG. 7 depicts KVT entries that are used to implement the hierarchical structure of FIG. 6 in accordance with an embodiment of the invention.

FIG. 8 depicts KVT entries for tracking back-references from a chunk to objects in accordance with an embodiment of the invention.

FIG. 9 is a simplified diagram showing components of a computer apparatus that may be used to implement elements (including, for example, client computers, gateway servers and storage servers) of an object storage system.

### DETAILED DESCRIPTION

### Challenges and Problems

The present invention seeks to extend solutions that can be offered by fully distributed object clusters with eventual consistency to allow concurrent support of transactional updates to objects under protocol rules common for file storage protocols.

Eventual completion semantics are inherently compatible with fully distributed solutions where multiple clients can be editing the same object concurrently without any requirement for real-time synchronization of all cluster components. The cluster can even be partitioned into two sub-networks temporarily unable to communicate with each other, and still allow updates within each sub-network which will be eventually reconciled with each other.

Transactional completion semantics, by contrast, require that the Initiator receive confirmation that their specific edit transaction has been completed without any conflict with any concurrently presented edits. Furthermore, the results of this transaction will be available for any subsequent transaction by any client. This may be accomplished by some form of distributed locking where the Initiator temporarily obtains a cluster-wide exclusive lock on the right to update the target object/file, or by Multi-Versioned Concurrency Control (MVCC) strategies which confirm the absence of conflicting edits before completing a cluster-wide commit of the edit. MVCC strategies are sometimes called “optimistic locking”. They improve throughput considerably when their optimistic assumption that there are no other concurrent conflicting edits proves to be justified, but they do increase the worst case transaction time when there are conflicting concurrent edits to be reconciled.

To meet the increasing demands to scale out storage, an object storage cluster may distribute not only payload data, but also object metadata. The specific area of interest for the present invention are storage clusters which allow concurrent processing of metadata objects to a single object/file to proceed concurrently. Serializing metadata updates to a single object to a single active server certainly simplifies processing, but severely limits the scalability of the cluster.

The metadata for an object may be distributed to different storage servers based, for example, upon the object name, which may be uniquely identified. However, as is pertinent to the present disclosure, while such distribution of metadata has its advantages, it may also pose substantial problems. Of particular interest, a distributed object storage system may support both eventual edits and transactional edits to the distributed metadata.

An eventual edit to data may be held for completion at a later time because only eventual consistency is required, and eventual consistency allows two concurrent edits to be made to the same object. On the other hand, a transactional edit to data may not be held for completion at a later time.

In such systems that support both eventual and transactional edits, a transactional edit to an object may not be completed while there are pending eventual edits. However, completing all pending eventual edits before any transactional edit would require a substantial amount of overhead in terms of system resources and bandwidth.

### Presently-Disclosed Solution

The presently-disclosed solution deals with eventual and transactional edits to data from multiple concurrent sources where the metadata has specific characteristics. The metadata is advantageously defined and identified as a set of records, and most importantly the identity of the records to be inserted or replaced must not be dependent on relative offset or anything else that is dependent upon referencing a specific prior version.

These ordering guarantees may apply to some payload data in addition to applying to the metadata. When it applies to the payload data, payload edits may be applied in any order, allowing low-overhead eventual editing techniques to be applied. Even when it is only true of the object metadata, inclusion of some form of ‘generation” metadata (which documents the version of the object that the initiator based its edits upon) can guarantee, even if two transactions edit the same object concurrently, that both versions put will survive with unique identities and that eventually the entire cluster will agree on which version is the ‘winner’ (and also whether there was any risk that the ‘winning’ version may have ignored updates in the earlier ‘losing’ edits).

As disclosed herein, supporting both eventual and transactional semantics may be accomplished for a distributed storage cluster supporting concurrent edits of the same object/file when all object/file key/value metadata records include unique identifiers and where all payloads either meet the same requirement or are only referenced through metadata containing unique identifiers. For example, in an exemplary implementation, the solution may also be used to edit metadata that tracks back-references from referenced chunks to referencing manifests. More generally, the solution is applicable for any data where the record can be parsed as having a unique key value and a resulting value.

As disclosed herein, it is rare for data not designed specifically as key-value records to have these characteristics. For example, consider a document that has a sequence of seven paragraphs as of version V1 and then two edits are received both based on version V1. The first edit, V2A, replaces the third and fourth paragraphs with three new paragraphs (V2A-1, V2A-2 and V2A-3), while the second edit, V2B, replaces the same third and fourth paragraphs with two new paragraphs (V2B-1 and V2B-2). It would be challenging for a natural intelligence, say the boss of the two engineers both seeking to fix the same flaw in V1, to determine what the correct new version should be. Having the two conflicting editors talk with each other may be required. For this type of data, the best any automated algorithm can hope to do is to identify conflicting edits. The exemplary distributed object storage system does not seek to do more than identify such conflicts while providing eventual consistency.

In one embodiment of the presently-disclosed solution, both version tracking metadata and back-reference tracking metadata are implemented in a way such that the key portion of the key-value record includes a unique version identifier. An exemplary implementation of the unique version identifier is comprised of a fine-grained timestamp and a source identifier, where the timestamp is fine-grained in that each source is constrained to generate at most one update of a file or object within the same timestamp tick. When data is composed of such key-value records in a sorted order, merge sort algorithms may be used to reliably merge a set of edits to an old master image to produce a new master image, even if the merge/sort is performed on a distributed basis. In other words, a sorted set of such key-value records may be sub-divided into N smaller sets, and may be still treated as though they represented a single sorted list, through the application of a merge sort algorithm. This is because, under these conditions, the result of merging a known set of edits to a known master is also known, no matter what order the edits are applied. This capability to reliably merge a set of edits on a distributed basis has practical application in sub-dividing an update to a large database, for example, even when the entire set of the update comes from multiple sources.

A straightforward solution to allow both eventual and transactional updates of key-value data is to defer merging of eventual edits when doing so improves throughput but complete the eventual edits before any transactional edit is performed. However, such a straightforward solution is sub-optimal. This is because performance of a large-number of eventual edits may need to be completed before a transactional edit is performed, resulting in substantial latency before performing the transactional edit.

In contrast, the presently-disclosed solution minimizes the number of edits that are required to be performed before a transactional edit is performed. In particular, the number of edits is minimized or tailored to the set of pending edits which potentially impact the transactional edit.

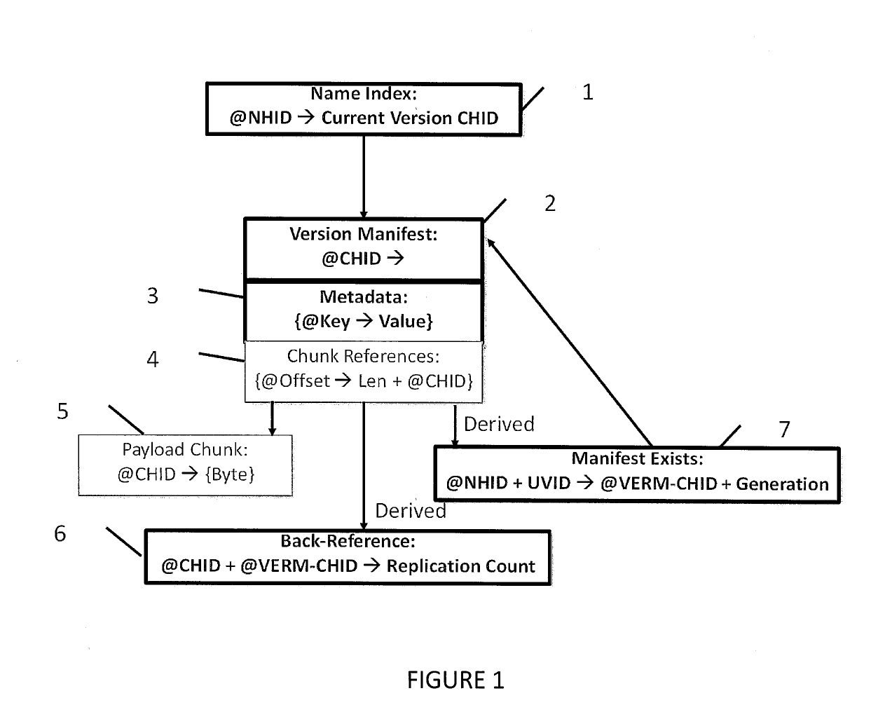

FIG. 1 illustrates an exemplary set of metadata involved in a copy-on-write distributed storage cluster suitable for storing POSIX-compliant files and/or eventually consistent objects (such as provided under the Amazon S3™ or OpenStack™ Swift protocols). The storage cluster stores named files or objects, and each named file or object is identified by a cryptographic hash of its name (referred to as a name hash identifier or NHID). A name index (1) may contain an entry for each named file or object stored in the system, indexed by the NHID of the file or object, and the entry may include a content hash identifier or CHID for a most-recent version manifest of the file or object (the current version CHID).

A version manifest (2) is a metadata chunk that specifies the contents of a specific version of a file or object. Other storage systems may refer to equivalent entities as an “inode” or as a “catalog”. The presently-disclosed solution has been designed for storage clusters, where the version manifest or equivalent is a “create once” entity, which is created at most once and is identified by a cryptographic hash of its contents (referred to as a content hash identifier or CHID).

The contents of a version manifest include many metadata key-value name pairs (3) representing system and user metadata attributes of the object version. In an exemplary implementation, certain system metadata values, such as the fully-qualified object name and a unique version identifier, are mandatory in that target storage servers will not accept a put of a version manifest lacking these fields.

The version manifest also includes zero or more chunk references (4) which refer to object/file payload chunks for this version of the object/file. A typical chunk reference identifies its logical offset and logical length, and the CHID of a payload chunk holding this content. Many distributed storage solutions will also support in-line chunks which include payload within the chunk reference rather than referring to another chunk. The handling of any such chunk-references is not impacted by the current invention.

Note that for simplicity, the following explanation will assume that the version manifest is complete in a single chunk. Actual implementations will typically include some mechanism to segment larger manifests into a single root manifest and referenced manifests.

The payload chunks (5) referenced by their CHIDs in a version manifest are typically not amenable to commutative editing. Only in exceptional cases can transactions to append content, after the prior content, be applied out of order. That is, it would be rare to end up with the same N append operations ultimately being applied in timestamp order to produce the same content for all replicas no matter in what order the append operations are applied. For example, consider the semantics of a source code edit to replace “static void my_func(int x)” currently on line 73 with “static void my_func(unsigned x)”. An intermediate version which inserted a new function that is twenty lines long at line 50 would make application of the edit at a fixed offset semantically invalid.

An enumeration of back-references (6), by contrast, is a set. Members can be added to a set in any order. Hence, as long as the same back-reference entries are specified, the end result is the same even if the new back-reference entries were added in different orders.

There are also derivatives of the version manifest that are maintained in an exemplary implementation. One derivative is a collection of key-value records where each record defines a back-reference which enumerates that a given payload chunk is referenced by a specific manifest. This information, however distributed, allows detection of orphan payload junks that no longer need to be retained.

Other data that may be derived from the version manifest includes a collection, or collections, of key-value records, where each key-value record (7) records the existence of a single version manifest. Such a key-value record may specify, as the key, a given file/object fully-qualified name (represented by its hash value, or name hash ID, or NHID for short) combined with a unique version identifier (UVID) and may specify, as the value, the CHID of the existing version manifest (VERM-CHID) and a generation number. Other attributes from the version manifest may be cached to optimize processing of those fields.

In FIG. 1, certain metadata (namely, 1, 2, 3, 6 and 7) is amenable to commutable operations and may be referred to as guaranteed-commutable data. Such data is defined so that updates are commutable such that they can be applied in any order. As long as the full set of updates is received, the end results are the same. These guaranteed-commutative data include: the name index entries (1); the version manifests (2), including the metadata key-value name pairs (3); the back-references (6); and the key-value records (7) that each indicates a version manifest exists. The solution disclosed herein may be applied to guaranteed-commutable data.

On the other hand, other data (4 and 5) cannot be guaranteed to be amendable to commutable operations and may be referred to as non-guaranteed-commutable data. While chunk references (4) and payload chunks (5) might be amenable to commutable edits, the storage cluster cannot make this assumption without explicit guarantees being made by the end user. The solution disclosed herein cannot be applied to data that is not guaranteed to be commutable.

In this type of distributed storage system transactional editing of payload data can be supported even when the commutable editing of payload data is not supported. The unique versioning of metadata records allows the Initiator to confirm that a new version put is the next successor to a base version, effectively implementing a kind of MVCC (multiversion currency control) strategy to serialize updates to the object/file.

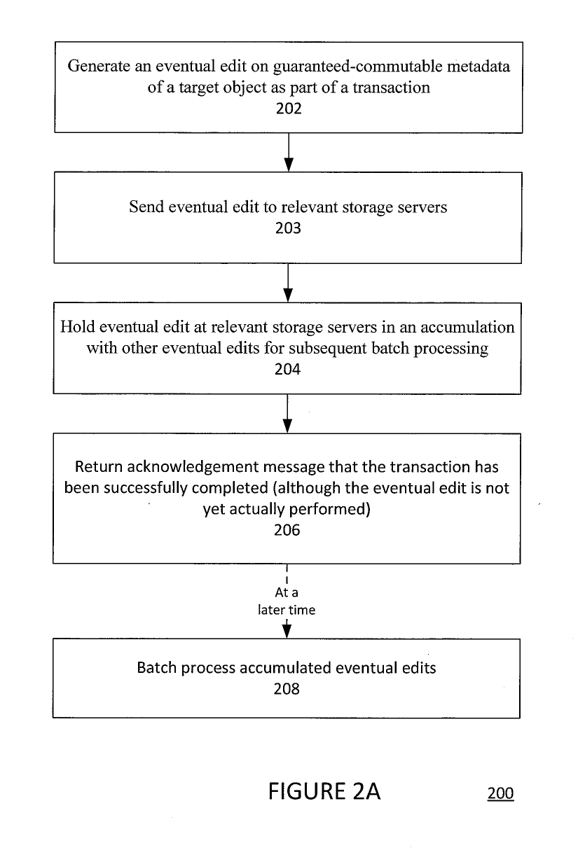

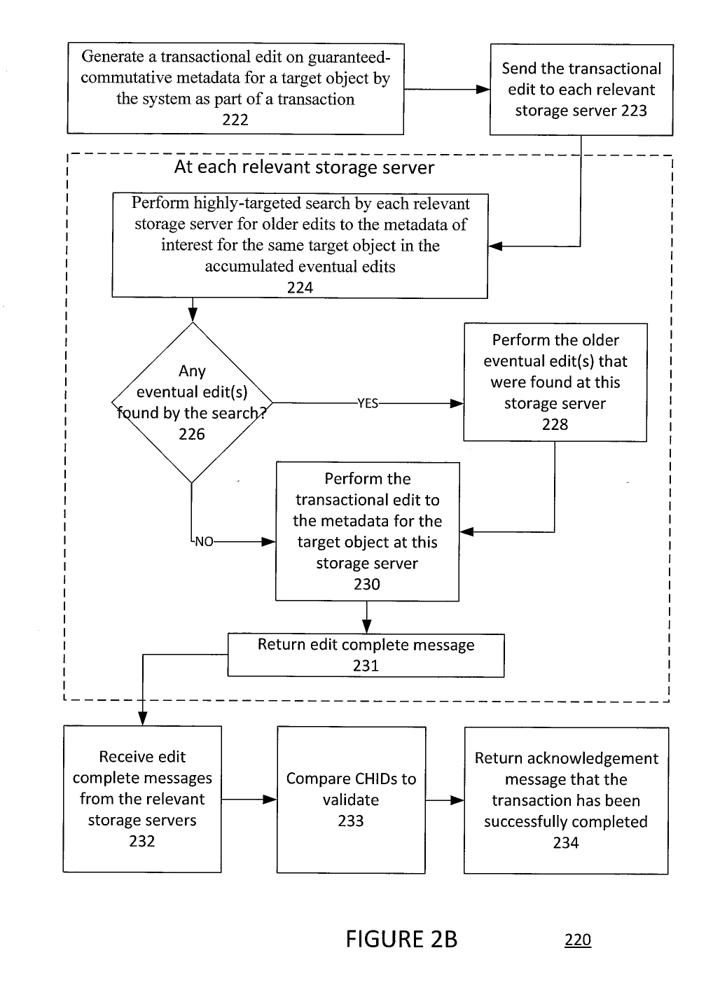

FIG. 2A is a flow chart of a method 200 of performing an eventual edit of guaranteed-commutable data in accordance with an embodiment of the invention. The method 200 utilizes batch processing such that the eventual edits are performed efficiently.

Per block 202, an eventual edit on guaranteed-commutable metadata for a target object may be generated by the system (for example, by a gateway server) as part of a transaction. For example, the transaction may be to put a new version of the target object to the system, and fulfilling the request may involve editing various metadata, such as editing the current version CHID in the name index and editing back-references, for example.

Per block 203, the eventual edit may be sent to the relevant storage servers in the system. The relevant storage servers may be the group or groups of storage servers in the system that store the metadata for the target object.

Per block 204, the eventual edit may be held at the relevant storage servers in an accumulation with other eventual edits for subsequent batch processing. The accumulation of eventual edits at each relevant storage server may include eventual edits to guaranteed-commutative metadata for different objects.

Per block 206, an acknowledgement message may be generated by the system (i.e. by the gateway server) and returned to the requesting client as soon as the pending edit is saved persistently. It is not necessary to fully merge the pending transaction batch with the prior master set of records. The acknowledgement message may indicate that the transaction (which required the eventual edit to the metadata) was successfully completed. This is allowable because, although the eventual edit to the guaranteed-commutative metadata has not yet been performed, it will be eventually performed during subsequent batch processing. This merger will eventually occur even if there is a restart of the storage server before the merger has occurred.

Per block 208, at a later time, such accumulated eventual edits may be processed in a batch or batches by each of the relevant storage servers. For example, the batch processing may be done periodically, or when the accumulated eventual edits reach a predetermined level, or when a relevant storage server has a less busy period. It will also typically be done as a by-product of any query of the chunk. Since a complete image of the merged records must be formed as the response, it will generally be advantageous to save that image persistently to disk, rather than re-performing those same merge operations at a later time.

FIG. 2B is a flow chart of a method 220 of performing a transactional edit on guaranteed-commutable metadata for an object stored in a distributed object storage system in accordance with an embodiment of the invention. This method 220 is advantageous in that, instead of requiring the merging of the entire accumulation of pending eventual edits to form a new metadata master, this method 220 performs a highly targeted search for certain pending eventual edits and processes just those edits before performing the transactional edit. This is particularly advantageous in that the set of pending eventual edits which impact the transactional edits will very commonly be an empty set.

Per block 222, a transactional edit on guaranteed-commutative metadata for a target object is generated by the system (for example, by a gateway server or other initiating server in the system) as part of processing a transaction relating to the target object. For example, the transaction may involve a POSIX command to write a new version of a file object to the system, or the transaction may involve a request to expunge the file object from the system.

Per block 223, the transactional edit may be sent by the system (for example, by the gateway server) to each relevant storage server in the system. The relevant storage servers are those storage servers that are responsible for storage of the metadata being edited. Blocks 224 through 230 are then performed at each relevant storage server.

Per block 224, each relevant storage server may perform a highly-targeted search in its accumulation of eventual edits for any older eventual edit to the same metadata of the same target object as the transactional edit. Two edits may be non-conflicting when they both merely add or remove records from a key/value record store. In the exemplary distributed object storage system cited in FIG. 1, this is true for the derived record stores tracking the existence of object versions and tracking back-references. It may be true for some objects themselves. An eventual edit may be considered as older when its timestamp is earlier than a timestamp associated with the transactional edit.

Per block 226, a determination may be made by each relevant storage server as to whether any eventual edits are found by the search. If any eventual edit is found by the search, then the method 220 may move forward to block 228. In the typical case where no eventual edit is found by the search, the method 220 may move forward to block 230.

Per block 228, the relevant storage server may process the eventual edits that were found, if any, in block 226. The order of processing these edits does not impact the end result for the metadata being edited. This is because the metadata being edited is guaranteed commutative.

Advantageously, the relevant storage server does not have to perform any of the accumulated eventual edits that are for objects that are different from the target object or that are for later transactions (even if they are to the same target object). This reduces the resources, bandwidth, and latency that are required before performing the transactional edit to the metadata of the target object.

Per block 230, the relevant storage server performs the transactional edit. The order of performing the eventual edits in block 228 and the transactional edit in block 230 does not impact the end result for the metadata being edited. This is because the metadata being edited is guaranteed commutative. After the step of block 230 is performed, the metadata for the target object is up-to-date at this storage server in that all edits to the metadata up to the timestamp of the transactional edit have been performed.

Per block 231, since the storage server has performed all edits to the metadata up to the timestamp of the transactional edit, the storage server may generate and return an edit complete message to the system (i.e. to the gateway server). The edit complete message indicates that this storage server has completed the transactional edit.

Per block 232, the edit complete messages may be received by the system (e.g., by the gateway server or other initiating server) from all the relevant storage servers. This indicates that the system has successfully performed the transactional edit generated in step 222. In an exemplary implementation, each edit complete message includes a content hash identifier (CHID) of the resultant metadata (after the edit).

Per block 233, the initiating server may compare these CHIDs to validate that the transactional edit has been performed correctly. For example, only servers reporting concurring CHIDs may be considered to have completed the transactional edit correctly.

Per block 234, an acknowledgement message may be generated by the system (i.e. by the gateway server) and returned to the requesting client. The acknowledgement message may indicate that the transaction (which required the transactional edit to the metadata) was successfully completed.

### Exemplary Distributed Object Storage System

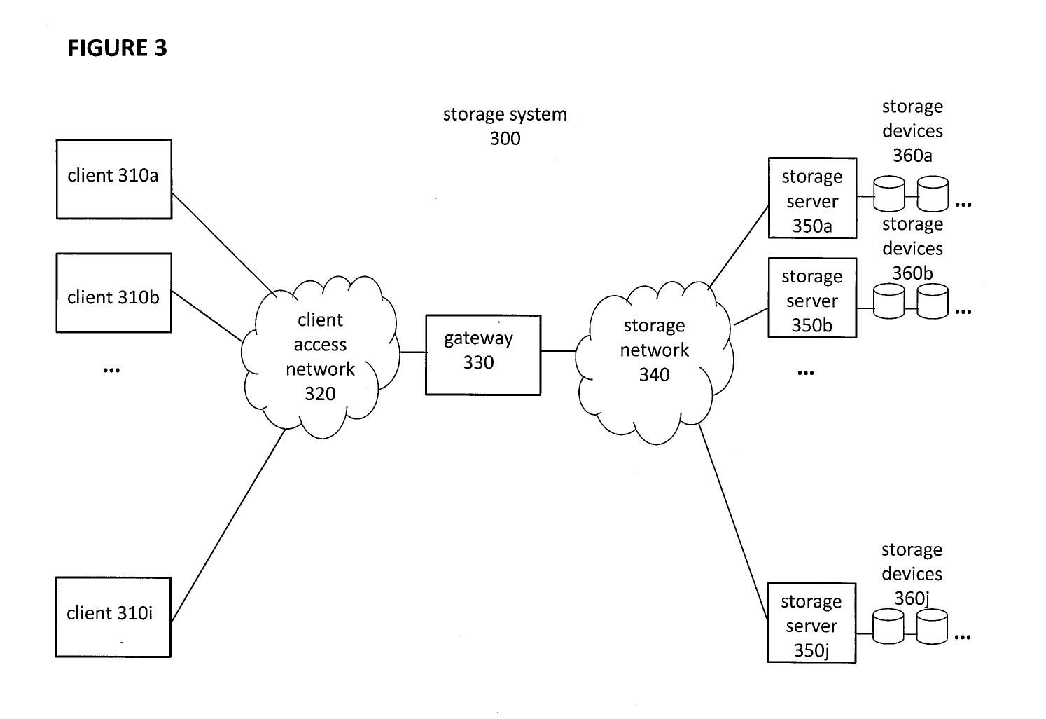

FIG. 3 depicts an exemplary object storage system 300 in which the presently-disclosed solutions may be implemented. The object storage system 300 supports hierarchical directory structures (i.e. hierarchical user directories) within its namespace. The namespace itself is stored as a distributed object. When a new object is added or updated as a result of a put transaction, metadata relating to the object's name may be (eventually or immediately) stored in a namespace manifest shard based on the partial key derived from the full name of the object.

The object storage system 300 comprises clients 310a, 310b, . . . 310i (where i is any integer value), which access gateway 330 over client access network 320. There can be multiple gateways and client access networks, and that gateway 330 and client access network 320 are merely exemplary. Gateway 330 in turn accesses Storage Network 340, which in turn accesses storage servers 350a, 350b, . . . 350j (where j is any integer value). Each of the storage servers 350a, 350b, . . . , 350j is coupled to a plurality of storage devices 360a, 360b, . . . , 360j, respectively.

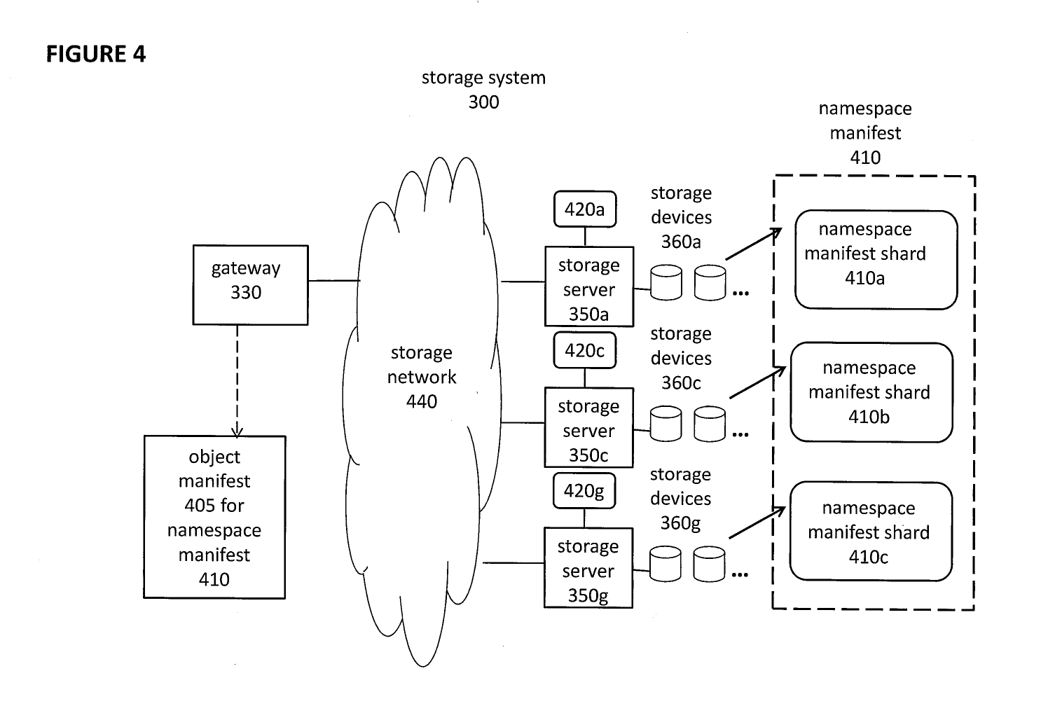

FIG. 4 depicts certain further aspects of the storage system 300 in which the presently-disclosed solutions may be implemented. As depicted, gateway 330 can access object manifest 405 for the namespace manifest 410. Object manifest 305 for namespace manifest 410 contains information for locating namespace manifest 410, which itself is an object stored in storage system 300. In this example, namespace manifest 410 is stored as an object comprising three shards, namespace manifest shards 410a, 410b, and 410c. This is representative only, and namespace manifest 410 can be stored as one or more shards. In this example, the object has been divided into three shards and have been assigned to storage servers 350a, 350c, and 350g. Typically each shard is replicated to multiple servers as described for generic objects in the Incorporated References. These extra replicas have been omitted to simplify the diagram.

The role of the object manifest is to identify the shards of the namespace manifest. An implementation may do this either as an explicit manifest which enumerates the shards, or as a management plane configuration rule which describes the set of shards that are to exist for each managed namespace. An example of a management plane rule would dictate that the TenantX namespace was to spread evenly over twenty shards anchored on the name hash of “TenantX”.

In addition, each storage server maintains a local transaction log. For example, storage server 350a stores transaction log 420a, storage server 350c stores transaction log 420c, and storage server 350g stores transaction log 420g.

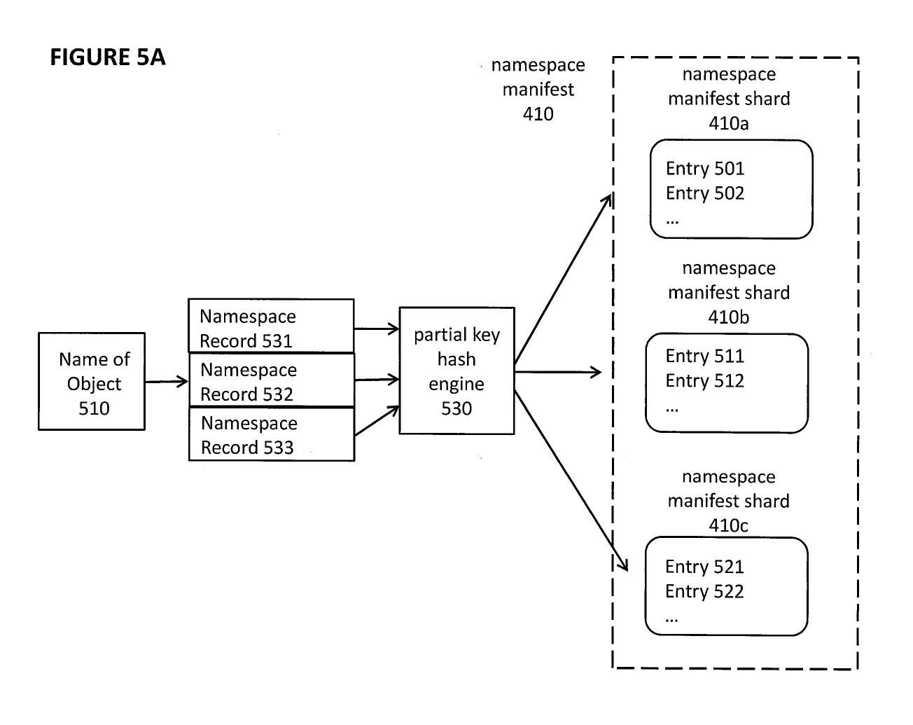

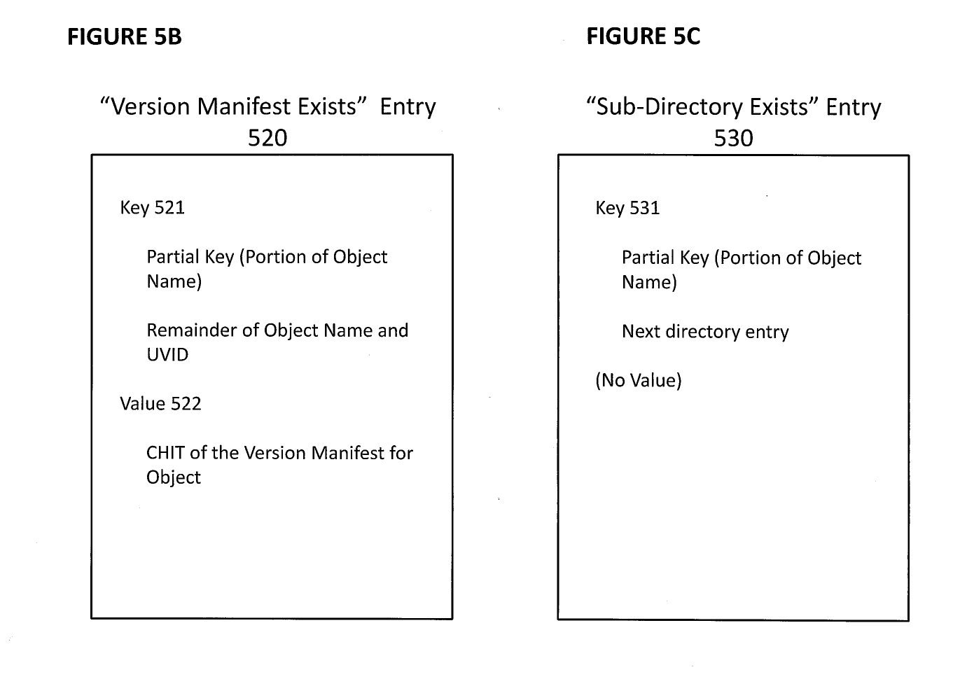

With reference to FIG. 5A, the relationship between object names and namespace manifest 410 is depicted. Exemplary name of object 510 is received, for example, as part of a put transaction. Multiple records (here shown as namespace records 531, 532, and 533) that are to be merged with namespace manifest 410 are generated using the iterative or inclusive technique previously described. The partial key has engine 530 runs a hash on a partial key (discussed below) against each of these exemplary namespace records 531, 532, and 533 and assigns each record to a namespace manifest shard, here shown as exemplary namespace manifest shards 410a, 410b, and 410c.

Each namespace manifest shard 410a, 410b, and 410c can comprise one or more entries, here shown as exemplary entries 501, 502, 511, 512, 521, and 522.

The use of multiple namespace manifest shards has numerous benefits. For example, if the system instead stored the entire contents of the namespace manifest on a single storage server, the resulting system would incur a major non-scalable performance bottleneck whenever numerous updates need to be made to the namespace manifest.

With reference now to FIGS. 5B and 5C, the structure of two possible entries in a namespace manifest shard are depicted. These entries can be used, for example, as entries 501, 502, 511, 512, 521, and 522 in FIG. 5A.

FIG. 5B depicts a “Version Manifest Exists” (object name) entry 520, which is used to store an object name (as opposed to a directory that in turn contains the object name). The object name entry 520 comprises key 521, which comprises the partial key and the remainder of the object name and the unique version identifier (UVID). In the preferred embodiment, the partial key is demarcated from the remainder of the object name and the UVID using a separator such as “|” and “\” rather than “/” (which is used to indicate a change in directory level). The value 522 associated with key 521 is the CHIT of the version manifest for the object 510, which is used to store or retrieve the underlying data for object 510.

FIG. 5C depicts “Sub-Directory Exists” entry 530. The sub-directory entry 530 comprises key 531, which comprises the partial key and the next directory entry. For example, if object 510 is named “/Tenant/A/B/C/d.docx,” the partial key could be “/Tenant/A/”, and the next directory entry would be “B/”. No value is stored for key 531.

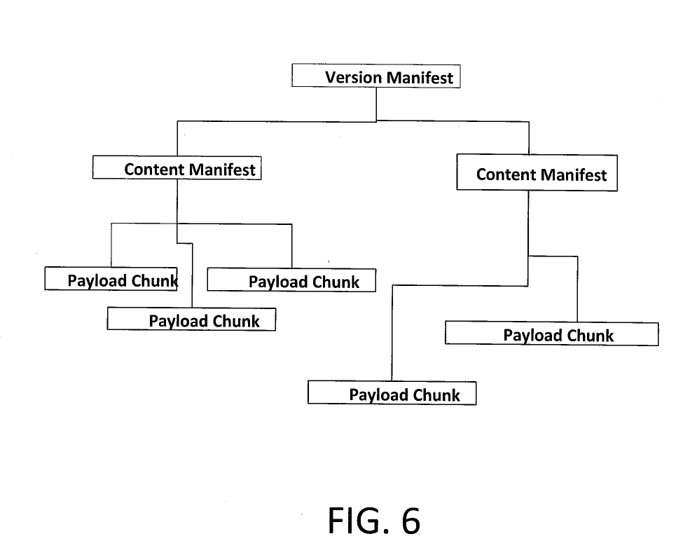

FIG. 6 depicts a hierarchical structure for the storage of an object into chunks in accordance with embodiment of the invention. The top of the structure is a Version Manifest that may be associated with a current version of an Object. The Version Manifest holds the root of metadata for an object and has a Name Hash Identifying Token (NHIT). As shown, the Version Manifest may reference Content Manifests, and each Content Manifest may reference Payload Chunks. Note that a Version Manifest may also directly reference Payload Chunks and that a Content Manifest may also reference further Content Manifests.

In an exemplary implementation, a Version Manifest contains a list of Content Hash Identifying Tokens (CHITs) that identify Payload Chunks and/or Content Manifests and information indicating the order in which they are combined to reconstitute the Object Payload. The ordering information may be inherent in the order of the tokens or may be otherwise provided. Each Content Manifest Chunk contains a list of tokens (CHITs) that identify Payload Chunks and/or further Content Manifest Chunks (and ordering information) to reconstitute a portion of the Object Payload.

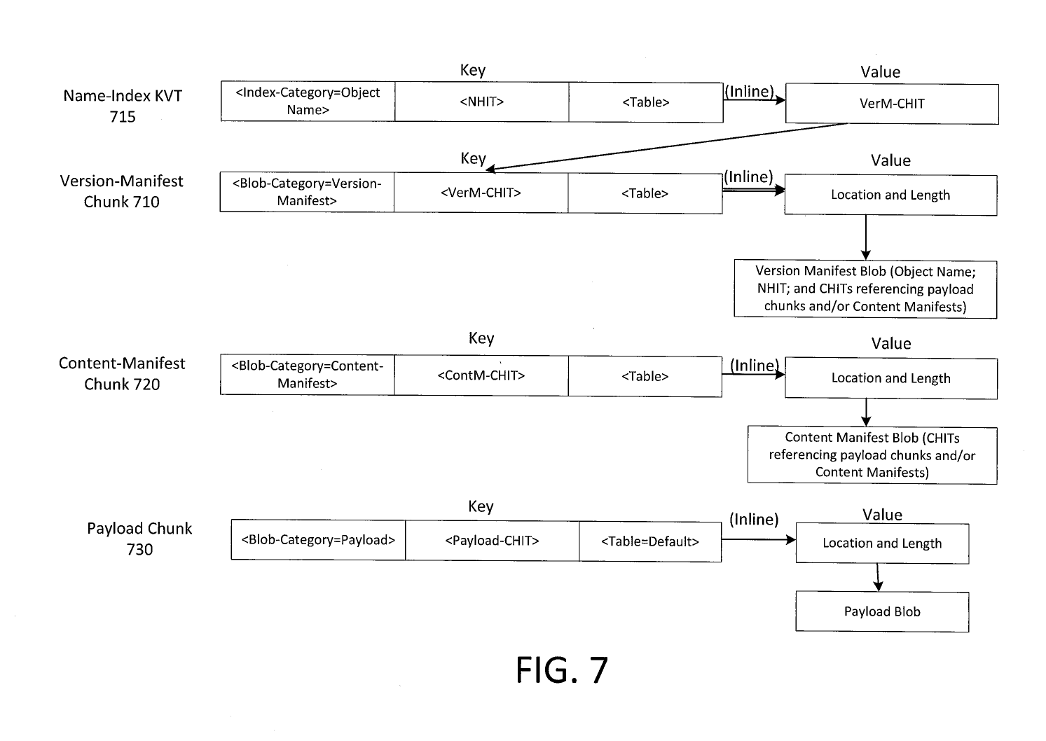

FIG. 7 depicts key-value tuples (KVTs) that are used to implement the hierarchical structure of FIG. 6 in accordance with an embodiment of the invention. Depicted in FIG. 4B are a Version-Manifest Chunk 710, a Content-Manifest Chunk 720, and a Payload Chunk 730. Also depicted is a Name-Index KVT 715 that relates an NHIT to a Version Manifest 715.

The Version-Manifest Chunk 710 includes a Version-Manifest Chunk KVT and a referenced Version Manifest Blob. The Key of the Version-Manifest Chunk KVT has a <Blob-Category=Version-Manifest> that indicates that the Content of this Chunk is a Version Manifest. The Key also has a <VerM-CHIT> that is a CHIT of the Version Manifest Blob. The Value of the Version-Manifest Chunk KVT points to the Version Manifest Blob. The Version Manifest Blob contains CHITs that reference Payload Chunks and/or Content Manifest Chunks, along with ordering information to reconstitute the Object Payload. The Version Manifest Blob may also include the Object Name and the NHIT.

The Content-Manifest Chunk 720 includes a Content-Manifest Chunk KVT and a referenced Manifest Contents Blob. The Key of the Content-Manifest Chunk KVT has a <Blob-Category=Content-Manifest> that indicates that the Content of this Chunk is a Content Manifest. The Key also has a <ContM-CHIT> that is a CHIT of the Content Manifest Blob. The Value of the Content-Manifest Chunk KVT points to the Content Manifest Blob. The Content Manifest Blob contains CHITs that reference Payload Chunks and/or further Content Manifest Chunks, along with ordering information to reconstitute a portion of the Object Payload.

The Payload Chunk 730 includes the Payload Chunk KVT and a referenced Payload Blob. The Key of the Payload Chunk KVT has a <Blob-Category=Payload> that indicates that the Content of this Chunk is a Payload Blob. The Key also has a <Payload-CHIT> that is a CHIT of the Payload Blob. The Value of the Payload Chunk KVT points to the Payload Blob.

Finally, a Name-Index KVT 715 is also shown. The Key of the Name-Index KVT has an <Index-Category=Object Name> that indicates that this index KVT provides Name information for an Object. The Key also has a <NHIT> that is a Name Hash Identifying Token. The NHIT is an identifying token of an Object formed by calculating a cryptographic hash of the fully-qualified object name. The NHIT includes an enumerator specifying which cryptographic hash algorithm was used as well as the cryptographic hash result itself.

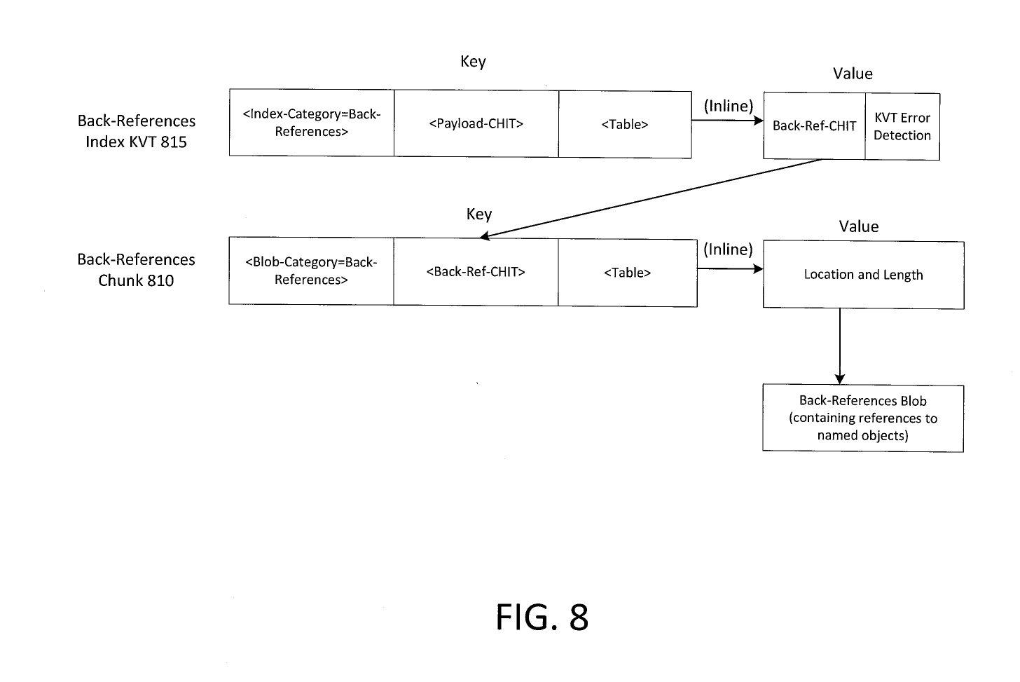

While FIG. 7 depicts the KVT entries that allow for the retrieval of all the payload chunks needed to reconstruct an object payload, FIG. 8 depicts KVT entries that allow tracking of all the objects to which a payload chunk belongs. The tracking is accomplished using back-references from a payload chunk back to objects to which the payload chunk belongs.

A Back-Reference Chunk 810 is shown that includes a Back-References Chunk KVT and a Back-References Blob. The Key of the Back-Reference Chunk KVT has a <Blob-Category=Back-References> that indicates that this Chunk contains Back-References. The Key also has a <Back-Ref-CHIT> that is a CHIT of the Back-References Blob. The Value of the Back-Reference Chunk KVT points to the Back-References Blob. The Back-References Blob contains NHITs that reference the Name-Index KVTs of the referenced Objects.

A Back-References Index KVT 815 is also shown. The Key has a <Payload-CHIT> that is a CHIT of the Payload to which the Back-References belong. The Value includes a Back-Ref CHIT which points to the Back-Reference Chunk KVT.

### Simplified Illustration of a Computer Apparatus

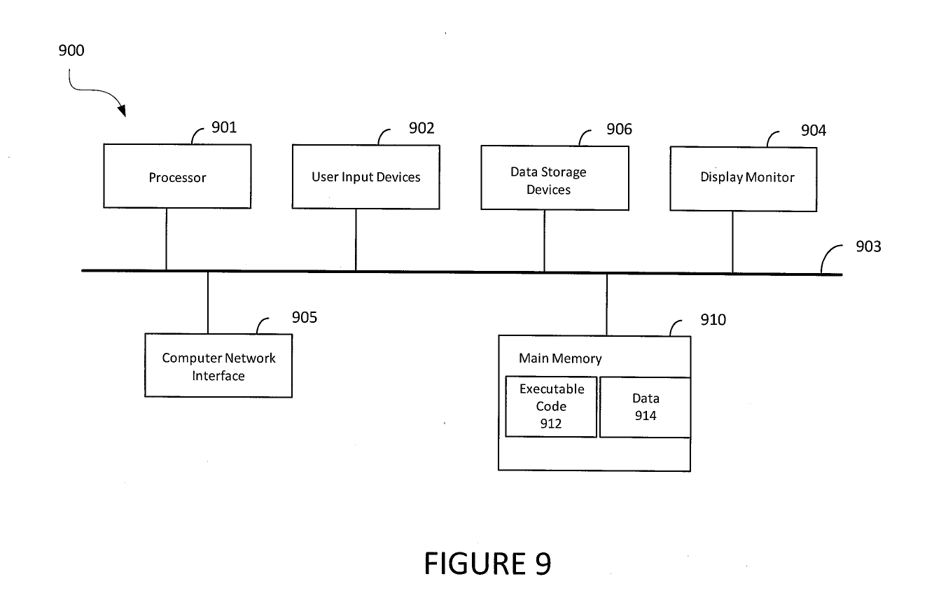

FIG. 9 is a simplified illustration of a computer apparatus that may be utilized as a client or a server of the storage system in accordance with an embodiment of the invention. This figure shows just one simplified example of such a computer. Many other types of computers may also be employed, such as multi-processor computers, for example.

As shown, the computer apparatus 900 may include a microprocessor (processor) 901. The computer apparatus 900 may have one or more buses 903 communicatively interconnecting its various components. The computer apparatus 900 may include one or more user input devices 902 (e.g., keyboard, mouse, etc.), a display monitor 904 (e.g., liquid crystal display, flat panel monitor, etc.), a computer network interface 905 (e.g., network adapter, modem), and a data storage system that may include one or more data storage devices 906 which may store data on a hard drive, semiconductor-based memory, optical disk, or other tangible non-transitory computer-readable storage media 907, and a main memory 910 which may be implemented using random access memory, for example.

In the example shown in this figure, the main memory 910 includes instruction code 912 and data 914. The instruction code 912 may comprise computer-readable program code (i.e., software) components which may be loaded from the tangible non-transitory computer-readable medium 907 of the data storage device 906 to the main memory 910 for execution by the processor 901. In particular, the instruction code 912 may be programmed to cause the computer apparatus 900 to perform the methods described herein.

What is claimed is:

1. A method of processing transactional edits to distributed metadata in an object storage cluster without first applying all pending edits submitted under eventual consistency, the method comprising:
storing the distributed metadata in a form that is guaranteed to be commutative;
generating a transactional edit on the distributed metadata for a target object as part of a transaction relating to the target object;
sending the transactional edit to a plurality of storage servers of the object storage cluster, wherein the plurality of storage servers that are responsible for storing the distributed metadata for the target object;
each of the plurality of storage servers performing a search in an accumulation of the eventual edits for older edits to the distributed metadata for the target object;
each of the plurality of storage servers performing any older edits found by the search; and
each of the plurality of storage servers performing the transactional edit after performing any older edits found by the search.

2. The method of claim 1, further comprising:
receiving edit complete messages from the plurality of storage servers; and
when all other tasks of the transaction are complete, returning an acknowledgement message indicating that the transaction has been successfully completed.

3. The method of clam 1, wherein the distributed metadata comprises a key-value record of a key-value datastore, wherein the key-value record includes a unique key.

4. The method of claim 3, wherein the key-value record comprises an entry in a name index.

5. The method of claim 3, wherein the key-value record comprises metadata enumerating existence of a manifest specifying a single version of an object.

6. The method of claim 3, wherein the key-value records comprise a back reference from a chunk to an object.

7. A method performed by a storage server in an object storage cluster with distributed metadata, the method comprising:
receiving a request to perform an eventual edit of a key-value record of a key-value datastore, wherein the key-value record includes a unique key;
holding the eventual edit for subsequent batch processing;
receiving a request to perform a transactional edit on the key-value record of the key-value datastore;
searching accumulated eventual edits to the key-value datastore for older eventual edits to the key-value record;
performing older eventual edits to the key-value record if found by the searching; and
performing the transactional edit to the key-value record after performing the older eventual edits.

8. The method of claim 7, wherein the transactional edit comprises a POSIX-compliant command.

9. The method of claim 8, wherein the POSIX-compliant command comprises a write of a file.

10. The method of claim 7, wherein the method is performed by a distributed object storage system, the key-value record comprises object metadata for named objects, a namespace manifest for the named objects stored in the system is divided into namespace manifest shards, and the accumulated eventual edits are grouped per namespace manifest shard.

11. The method of claim 10, further comprising:
batch processing the accumulated eventual edits for the named objects associated with a namespace manifest shard.

12. The method of claim 11, wherein the object metadata comprises a namespace manifest entry that includes a content hash identifier token for a version manifest for a new version of an object that is being put to the system.

13. The method of claim 7, further comprising:
returning an acknowledgement message that the eventual edit has been successfully completed once the eventual edit is held for subsequent batch processing although the eventual edit is not yet performed.

14. The method of claim 13, further comprising:
returning an acknowledgement message that the transactional edit has been successfully completed after the transactional edit has been performed.

15. A system comprising:
a storage network that is used by a plurality of clients to access the distributed data storage system; and
a plurality of storage servers accessed by the storage network,
wherein the system holds an eventual edit of a key-value record of a key-value datastore for subsequent batch processing, and
wherein the system searches for and performs older eventual edits to the key-value record in an accumulated group of eventual edits to the key-value datastore before performing a transactional edit to the key-value record.

16. The system of claim 15, wherein the transactional edit comprises a POSIX-compliant command.

17. The system of claim 16, wherein the POSIX-compliant command comprises a write of a file.

18. The system of claim 15, wherein the system comprises a distributed object storage system, the key-value record comprises object metadata for named objects, a namespace manifest for the named objects stored in the system is divided into namespace manifest shards, and the accumulated eventual edits are grouped per namespace manifest shard.

19. The system of claim 18, wherein the system batch processes the accumulated eventual edits for the named objects associated with a namespace manifest shard.

20. The system claim 19, wherein the object metadata comprises a namespace manifest entry that includes a content hash identifier token for a version manifest for a new version of an object that is being put to the system.

21. The system of claim 15, wherein the system returns an acknowledgement message that the eventual edit has been successfully completed once the eventual edit is held for subsequent batch processing although the eventual edit is not yet performed.

22. The system of claim 21, wherein the system returns an acknowledgement message that the transactional edit has been successfully completed after the transactional edit has been performed.
